(19) United States
(12) Patent Application Publication
(10) Pub. No.: US 2008/0124186 A1
(43) Pub. Date: May 29, 2008

(54) Device for fastening an attachment to a measuring tube of a coriolis mass flowmeter

(75) Inventors: Dieter Binz, Hirschjberg (DE); Lothar Deppe, Gottingen (DE); Steffen Keller, Konstanz (DE); Frank Kassubek, Rheinfelden (DE); Kuno Hug, Heidelberg (DE); Reinhard Steinberg, Worbis (DE); Robert Huber, Ketsch (DE); Wolfgang Waldi, Nussloch-Maisbach (DE); Jorg Gebhardt, Mainz (DE); Rene Friedrichs, Rosdorf (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/984,303

(22) Filed: Nov. 15, 2007

(30) Foreign Application Priority Data
Nov. 22, 2006 (DE) 10 2006 055 030.7

(51) Int. Cl. G01F 1/84

(52) U.S. Cl. 411/378

(57) ABSTRACT

A device for fastening an attachment to a measuring tube of a Coriolis mass flowmeter, comprising a clamping part, which can be pushed onto the measuring tube and can be pressed against the measuring tube by clamping means, the clamping part being formed in the manner of a slotted conical hollow screw, which interacts with a corresponding cone nut as a clamping means in such a way that, when the cone nut is screwed onto the clamping part, the inwardly directed radial force created as a result presses the clamping part against the measuring tube.

### RELATED APPLICATIONS

This application claims priority under 35 U.S.C. §119 to German Patent Application No. 10 2006 055 030.7 filed in the German Patent Office on 22 Nov. 2006, the entire contents of which are hereby incorporated by reference in their entireties.

### TECHNICAL FIELD

A device for fastening an attachment to a measuring tube of a Coriolis mass flowmeter is disclosed, comprising a clamping part, which can be pushed onto the measuring tube and can be pressed against the measuring tube by clamping means.

The area for use of the present disclosure extends to Coriolis mass flowmeters. Meters of this type may be equipped with measuring tubes that are straight or curved in the form of a loop. The measuring tubes may also run singly or in pairs between the inlet side and the outlet side of the meter. The present disclosure is suitable in particular in connection with straight measuring tubes, but is not restricted to them.

### BACKGROUND INFORMATION

In accordance with the measuring principle of Coriolis mass flowmeters, the measuring tube flowed through by a fluid is induced by means of a suitable actuator to perform a periodic oscillation. The oscillating behavior is influenced by the fluid flow. This influence is recorded by sensors and sent to downstream signal processing. The mass flow can be determined by the signal processing from the phase difference of the measuring signal at various measuring points.

In the case of the meters of interest here, the measuring tube usually consists of titanium, tantalum, zirconium or alloys thereof.

To put the measuring principle described above into practice, corresponding attachments, such as actuators, sensors and the like, have to be attached to the measuring tube.

It is known from the general state of the art to fasten attachments to measuring tubes of Coriolis mass flowmeters by hard soldering, because this type of fastening has proven in practice to be stable with respect to oscillations. Since, however, hard soldering is accompanied by introduction of considerable heat in the region of the connecting point, thermal stresses can occur, with an adverse influence on the functional capability of the meter.

EP 1 074 821 A2 discloses fastening methods for attachments to a measuring tube of interest here as alternatives to the prior art described above. For example, it is proposed to fasten an annular metal body, serving for the fastening of attachments, on the measuring tube by shrink-fitting it on the measuring tube. The metal body shrink-fitted in this way is subsequently spot-welded to the measuring tube for positional fixing. Since this technical solution also involves introduction of considerable heat into the connecting point, the same disadvantages as in the case of the general state of the art described at the beginning (hard soldering) apply here.

As an alternative to this, it is proposed in the cited prior art to establish the fastening of attachments by clamping means to produce a press fit. Used as a clamping part for this purpose is an externally conical ring, the inside diameter of which corresponds substantially to the outside diameter of the measuring tube in the fastening region. This ring is pushed onto the measuring tube in the intended fastening region on the basis of a force acting parallel to the axis of the measuring tube, in an inner cone provided in a bore of the attachment and corresponding to the external cone of the externally conical ring, and is held there. This produces a press fit of the metal body on the measuring tube. Although this technical solution is free from disadvantageous introduction of heat, the production of mutually corresponding conical effective areas to create the clamping force is quite complicated in terms of technical production, since close tolerances have to be maintained here. Furthermore, the clamping means proposed here comprise quite a lot of individual components.

Proposed as a further alternative in this printed prior art is to press an annular clamping part on after it has been pushed onto the measuring tube, and then to weld it. Consequently, this alternative technical solution forms a kind of welded press fitting. On the one hand, this cannot be released again from the measuring tube; on the other hand, welding is also required in conjunction with the pressing on according to the technical teaching that is disclosed here.

### SUMMARY

An exemplary device is disclosed for fastening an attachment to a measuring tube of a Coriolis mass flowmeter The exemplary device comprises a clamping part, which can be pushed onto the measuring tube and can be pressed against the measuring tube by clamping means. The clamping part is formed in the manner of a slotted conical hollow screw, which interacts with a corresponding cone nut as a clamping means in such a way that, when the cone nut is screwed onto the clamping part, the inwardly directed radial force created as a result presses the clamping part against the measuring tube.

Another exemplary device is disclosed for fastening an attachment to a measuring tube of a Coriolis mass flowmeter. The another exemplary device comprises a clamping part, which can be pushed onto the measuring tube and can be pressed against the measuring tube by clamping means. The clamping part is formed in the manner of an annular pressure vessel with a flexible inner wall, which, as a result of being subjected to a hydrostatic pressure, produces an inwardly directed radial force by means of an axially movable annular plunger, in order to press the clamping part against the measuring tube.

### BRIEF DESCRIPTION OF THE DRAWINGS

Further exemplary measures are described in more detail below together with the description of two exemplary embodiments of the disclosure on the basis of the figures, in which:

FIG. 1a shows a perspective view of a clamping part in the manner of a slotted conical hollow screw,

FIG. 1b shows a schematic longitudinal section of the clamping part shown in FIG. 1a in the fitted state, and

FIG. 2 shows a longitudinal section of clamping means with a clamping part in the manner of an annular pressure vessel.

### DETAILED DESCRIPTION

An object of the present disclosure is to provide a solution for fastening an attachment to a measuring tube of a Coriolis mass flowmeter that has clamping means of a simple construction, can be fitted without the application of heat and if need be can also be released again from the measuring tube.

In the first alternative of the solution according to the disclosure, it is proposed to form the clamping part in the manner of a slotted conical hollow screw, which interacts with a corresponding cone nut as a clamping means in such a way that, when the cone nut is screwed onto the clamping part, the inwardly directed radial force created as a result presses the clamping part against the measuring tube.

The advantage of this solution is primarily that the cone function and clamping means function are put into practice by a single component, that is the conical screw. There is no need here for any additional clamping means that exert an axial force on the components to be clamped with respect to one another. As a result of the easy action of the threads, the realized principle of a hollow screw with a cone nut allows greater tolerances with regard to conicity to be accepted, which has corresponding advantages in terms of technical production.

The solution according to the disclosure is also free from the introduction of heat, so that thermal stresses are not to be feared here. The releasable connection between the clamping means and the measuring tube according to the disclosure allows simpler measuring tubes to be used, which can be exchanged with less effort, the clamping means being reusable. The solution according to the disclosure manages altogether with two individual parts.

According to a further measure, improving the disclosure, it is provided that the clamping part is equipped with a tool engaging portion for interaction with a clamping tool. In this way, the camping part can be securely held by the tool, in order to tighten the cone nut—possibly with a different tool. Such a tool engaging portion can be arranged alongside a cone thread portion on the clamping part extending from here. In this case, the tool engaging portion may be formed as a hexagonal portion or as a portion with parallel surfaces that is suitable for interaction with a wrench as a clamping tool. As an alternative to this, however, it is also conceivable to form the tool engaging portion as a radial blind hole in the clamping part in which a clamping pin can be inserted to hold the clamping part securely during the tightening of the cone nut.

In addition, the object according to the disclosure can also be achieved by the clamping part being formed in the manner of an annular pressure vessel with at least a flexible inner wall, which, as a result of being subjected to a hydrostatic pressure, produces an inwardly directed radial force by means of an axially movable annular plunger, in order to press the clamping part against the measuring tube.

This technical solution also manages without any introduction of heat and provides clamping means that enter into a releasable connection with the measuring tube. To this extent, reference is made to the advantage described above with respect to the alternative solution. The pressure chamber of the clamping part can be subjected to a liquid fluid in order to produce the necessary radial force. The required tightness of the seal between the annular plunger and the annular pressure vessel can be established by means of metallic sealing seats or additional sealing means. This technical solution is suitable in particular for environments with high requirements in terms of hygiene. Moreover, the radial force can be comfortably set in a wide range by means of the hydrostatic pressure.

In an exemplary embodiment, the annular pressure vessel, configured as a clamping part, comprises an outer wall that is opposite and alongside the flexible inner wall—which comes into contact with the measuring tube—, between which walls the pressure chamber is formed. In this case, the outer wall may likewise be flexible. Here, the pressure chamber can be formed in a simple way by an axial slit in the clamping part. To this extent, the pressure vessel may be configured as a one-piece component.

The annular plunger can be arranged on one of the end faces of the pressure vessel configured as a clamping part. With this positioning, the plunger can be accessed very well from the outside, so that it can be comfortably actuated to apply the radial force.

To actuate the annular plunger, that is to say for the axial movement of the same, at least one clamping screw can be provided, arranged axially parallel to the annular pressure vessel configured as a clamping part. However, it is also conceivable to distribute a number of clamping screws around the circumference of the annular plunger, so that a kind of flanged connection is obtained. This flanged connection allows a particularly high actuating force for the annular plunger to be produced as and when required by tightening the number of screws step by step. The screws thereby act between the plunger and the clamping part.

To put the solution according to the disclosure into practice, in the two alternatives presented above the minimum wall thickness of the measuring tube should be 1 mm. Otherwise, it would have to be feared that the measuring tube would be compressed at the fastening point as a result of high radial force, which on the one hand impairs the reliability of the clamping fastening and which on the other hand would falsify the measuring result, also because of the constriction of the measuring tube on the inner side. If required, thin-walled measuring tubes could be equipped with an annular stiffening sleeve portion, against which the clamping part presses. The stiffening sleeve portion is in this case to be dimensioned in such a way that no deformation is caused by the radial force of the clamping means.

The measuring tube can consist of titanium, tantalum, zirconium or alloys thereof, whereas the clamping part interacting with it may consist of a steel. This is so because the clamping principle according to the disclosure also allows the use of different materials. Steel proves to be particularly favorable for the production of the clamping means according to the disclosure, since this material can be easily worked and ensures the adequate stability that is required for the intended use. Stainless high-grade steel can be used as the material for the production of the clamping means according to the disclosure.

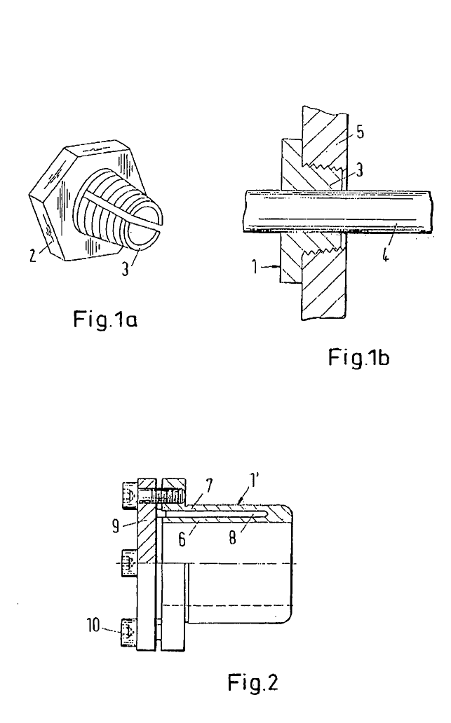

According to FIG. 1a, a clamping part 1, which is formed in the manner of a slotted conical hollow screw, is used for fastening an attachment (actuator, sensor and the like) —not represented any further—to a measuring tube of a Coriolis mass flowmeter. The clamping part 1 has a tool engaging portion 2 for interaction with a clamping tool—here a wrench—which is adjoined by a cone thread portion 3.

According to FIG. 1b, the clamping part 1 described above is pushed onto a measuring tube 4 of a Coriolis mass flowmeter—not represented any further. Subsequently, a cone nut 5 that matches the clamping part 1 is screwed onto it. An inwardly directed radial force is thereby exerted on the measuring tube 4 via the slotted cone thread portion 3, in order to fasten the clamping part 1 together with the cone nut 5 to the measuring tube 4 in the manner of a pressed connection. Attachments can subsequently be fastened to the cone nut 5, and consequently also to the measuring tube 4. In this exemplary embodiment, the measuring tube 4 consists of titanium, whereas the clamping part 1 and the cone nut 5 consist of a stainless high-grade steel.

According to FIG. 2, in the case of this exemplary embodiment a clamping part 1′ is formed in the manner of an annular pressure vessel. The annular pressure vessel substantially comprises a flexible inner wall 6, which is movable in the radial direction. Here, the outer wall 7 is likewise radially movable to a slight extent. The radial movement is produced as a result of subjecting a pressure chamber 8 that is formed between the inner wall 6 and the outer wall 7 to a hydrostatic pressure. The hydrostatic pressure is generated by means of an axially movable annular plunger 9 when it is displaced in the direction of the pressure chamber 8. The annular plunger 9 is arranged on an end face of the clamping part 1′.

For the axial movement of the annular plunger 9, a number of clamping screws 10 arranged axially parallel to the clamping part 1′ are provided. The clamping screws 10 form with an edge region of the clamping part 1′ a kind of flanged connection. The pressure chamber 8 is filled here with a hydraulic fluid. The sealing between the plunger 9 and the pressure chamber 8 takes place by means of metallic sealing surfaces.

The disclosure is not restricted to the exemplary embodiments described above. Rather, modifications of these that are covered by the scope of protection of the following claims are also conceivable. For example, it is also possible, in the case of the second exemplary embodiment, to provide other technical means instead of the flange-like screw connection to produce the force of the plunger, such as a union nut or the like.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

1 clamping part
2 tool engaging portion
3 cone thread portion
4 measuring tube
5 cone nut
6 inner wall
7 outer wall
8 pressure chamber
9 plunger
10 clamping screw

What is claimed is:

1. A device for fastening an attachment to a measuring tube of a Coriolis mass flowmeter, comprising a clamping part, which can be pushed onto the measuring tube and can be pressed against the measuring tube by clamping means, wherein the clamping part is formed in the manner of a slotted conical hollow screw, which interacts with a corresponding cone nut as a clamping means in such a way that, when the cone nut is screwed onto the clamping part, the inwardly directed radial force created as a result presses the clamping part against the measuring tube.

2. The device as claimed in claim 1, wherein the clamping part is equipped with a tool engaging portion for interaction with a clamping tool.

3. The device as claimed in claim 2, wherein the tool engaging portion is arranged alongside a cone thread portion of the clamping part extending from here.

4. The device as claimed in claim 2, wherein the tool engaging portion is formed as a hexagonal portion or a portion with parallel surfaces for interaction with a wrench as a clamping tool.

5. A device for fastening an attachment to a measuring tube of a Coriolis mass flowmeter, comprising a clamping part, which can be pushed onto the measuring tube and can be pressed against the measuring tube by clamping means, wherein the clamping part is formed in the manner of an annular pressure vessel with a flexible inner wall, which, as a result of being subjected to a hydrostatic pressure, produces an inwardly directed radial force by means of an axially movable annular plunger, in order to press the clamping part against the measuring tube.

6. The device as claimed in claim 5, wherein the annular pressure vessel, configured as a clamping part, comprises an outer wall that is opposite and alongside the flexible inner wall, between which walls a pressure chamber is formed.

7. The device as claimed in claim 5, wherein the annular plunger is arranged on one of the end faces of the pressure vessel configured as a clamping part.

8. The device as claimed in claim 5, wherein, for the axial movement of the annular plunger, at least one clamping screw is provided, arranged axially parallel to the annular pressure vessel configured as a clamping part.

9. The device as claimed in claim 5, wherein the pressure chamber is formed by an axial slit in the one-piece pressure vessel configured as a clamping part.

10. The device as claimed in claim 1, wherein the minimum wall thickness of the measuring tube is 1 millimeter.

11. The device as claimed in claim 1, wherein the measuring tube is equipped with an annular stiffening sleeve portion, against which the clamping part presses.

12. The device as claimed in claim 1, wherein the measuring tube consists of titanium, tantalum, zirconium or alloys thereof, whereas the clamping part interacting with it consists of a steel.

13. The device as claimed in claim 5, wherein the minimum wall thickness of the measuring tube is 1 millimeter.

14. The device as claimed in claim 5, wherein the measuring tube is equipped with an annular stiffening sleeve portion, against which the clamping part presses.

15. The device as claimed in claim 5, wherein the measuring tube consists of titanium, tantalum, zirconium or alloys thereof, whereas the clamping part interacting with it consists of a steel.
